(19) United States
(12) Patent Application Publication
(10) Pub. No.: US 2018/0178911 A1
(43) Pub. Date: Jun. 28, 2018

(54) UNMANNED AERIAL VEHICLE POSITIONING METHOD AND APPARATUS

(71) Applicants: AUTEL ROBOTICS CO., LTD., Shenzhen (CN); AUTEL HUNAN CO., LTD., Changsha (CN)

(72) Inventors: Zhihui LEI, Changsha (CN); Kaibin YANG, Changsha (CN); Yijie BIAN, Changsha (CN); Ning JIA, Changsha (CN)

(21) Appl. No.: 15/824,391

(22) Filed: Nov. 28, 2017

Related U.S. Application Data
(63) Continuation of application No. PCT/CN2017/072478, filed on Jan. 24, 2017.

(30) Foreign Application Priority Data
Dec. 28, 2016 (CN) 2016112363772

(51) Int. Cl. B64C 39/02; G06T 7/70; G06K 9/62; G06T 7/20; G05D 1/00; B64D 47/08; G05D 1/10

(52) U.S. Cl. CPC B64C 39/024; G06T 7/70; G06K 9/6202; G06T 7/20; B64C 2201/141; B64D 47/08; G05D 1/101; G06T 2207/20048; B64C 2201/146; G05D 1/0011

(57) ABSTRACT

An unmanned aerial vehicle positioning method and apparatus are provided. The method includes: when determining to perform a hovering operation, collecting a first ground image, where the first ground image is used as a reference image; and collecting a second ground image at a current moment; and determining a current location of an unmanned aerial vehicle according to the first ground image and the second ground image.

### CROSS-REFERENCE

This application is a continuation application of International Application No. PCT/CN2017/072478, filed Jan. 24, 2017, which claims priority of Chinese Patent Invention No. 2016112363772, filed Dec. 28, 2016, which is incorporated herein by reference in its entirety.

### BACKGROUND

### Technical Field

The present invention relates to the unmanned aerial vehicle control field, and specifically, to an unmanned aerial vehicle positioning method and apparatus.

### Related Art

Unmanned aerial vehicles are widely applied to fields such as disaster prevention, risk alleviation, and scientific exploration, and flight control systems (FCS for short) are important parts of unmanned aerial vehicles, and play a significant role in intelligence and practicability of unmanned aerial vehicles. Unmanned aerial vehicles usually need to hover in the air when performing a task.

In the prior art, an unmanned aerial vehicle may pre-store, in a storage module of the unmanned aerial vehicle, map data provided by a third-party, and is positioned by using the Global Positioning System (GPS) during hovering, to keep static during hovering. However, a resolution of map data provided by a third-party is related to a height of the unmanned aerial vehicle from the ground. Generally, a larger flight height of the unmanned aerial vehicle from the ground results in a smaller resolution. Because an unmanned aerial vehicle hovers at different heights when performing a task, resolutions of ground targets are significantly different when the unmanned aerial vehicle hovers at different heights, and matching precision of ground targets is low. As a result, positioning precision is relatively low when the unmanned aerial vehicle hovers. In addition, the Global Positioning System generally measures a horizontal location at a precision of a meter level, measurement precision is low, and an unmanned aerial vehicle easily shakes seriously when hovering. Therefore, how to improve positioning precision of an unmanned aerial vehicle is a technical problem that urgently needs to be resolved.

### SUMMARY

The present invention resolves the technical problem that how to improve positioning precision of an unmanned aerial vehicle. To this end, according to a first aspect, embodiments of the present invention provide an unmanned aerial vehicle positioning method, including:
when determining to perform a hovering operation, collecting a first ground image, where the first ground image is used as a reference image; collecting a second ground image at a current moment; determining a current location of an unmanned aerial vehicle according to the first ground image and the second ground image.

Optionally, the unmanned aerial vehicle positioning method provided in the embodiments of the present invention further includes: receiving an instruction sent by a controller, wherein the instruction is used to instruct the unmanned aerial vehicle to perform the hovering operation.

Optionally, the determining a current location of an unmanned aerial vehicle according to the first ground image and the second ground image includes: performing matching between the second ground image and the first ground image to obtain a motion vector of the unmanned aerial vehicle relative to the first ground image at the current moment; and determining positioning information of the unmanned aerial vehicle at the current moment relative to the first ground image according to the motion vector.

Optionally, the positioning information includes at least one of the following: location of the unmanned aerial vehicle, height of the unmanned aerial vehicle, posture of the unmanned aerial vehicle, azimuth of the unmanned aerial vehicle, speed of the unmanned aerial vehicle, and flight direction of the unmanned aerial vehicle.

Optionally, the performing matching between the second ground image and the first ground image to obtain a motion vector of the unmanned aerial vehicle at the current moment relative to the first ground image includes: selecting a characteristic point in the first ground image, where the selected characteristic point is used as a reference characteristic point; determining a characteristic point that is in the second ground image and that matches with the reference characteristic point, where the characteristic point obtained by matching is used as a current characteristic point; and performing matching between the current characteristic point and the reference characteristic point, to obtain the motion vector of the unmanned aerial vehicle relative to the first ground image at the current moment.

Optionally, the performing matching between the current characteristic point and the reference characteristic point includes: performing matching between the current characteristic point and the reference characteristic point by means of affine transformation or projective transformation.

According to a second aspect, the embodiments of the present invention provide an unmanned aerial vehicle, including:
an image collection apparatus configured to collect a first ground image used as a reference image; a processor; wherein the image collection apparatus is further configured to collect a second ground image at current moment; wherein the processor is configured to determine a current location of the unmanned aerial vehicle according to the first ground image and the second ground image.

Optionally, the unmanned aerial vehicle further includes: a radio signal receiver configured to receive an instruction sent by a controller, wherein the instruction is used to instruct the unmanned aerial vehicle to perform the hovering operation.

Optionally, the processor is configured to: perform matching between the second ground image and the first ground image to obtain a motion vector of the unmanned aerial vehicle at the current moment relative to the first ground image; and determine positioning information of the unmanned aerial vehicle at the current moment relative to the first ground image according to the motion vector.

Optionally, the positioning information includes at least one of the following: location of the unmanned aerial vehicle, height of the unmanned aerial vehicle, posture of the unmanned aerial vehicle, azimuth of the unmanned aerial vehicle, speed of the unmanned aerial vehicle, and flight direction of the unmanned aerial vehicle.

Optionally, the processor is configured to: select a characteristic point in the first ground image, wherein the selected characteristic point is used as a reference characteristic point; determine a characteristic point that is in the second ground image and that matches with the reference characteristic point, wherein the characteristic point in the second ground image is used as a current characteristic point; perform matching between the current characteristic point and the reference characteristic point in order to obtain the motion vector of the unmanned aerial vehicle at the current moment relative to the first ground image.

Optionally, the processor is configured to perform matching between the current characteristic point and the reference characteristic point by means of affine transformation or projective transformation.

The technical solutions of the present invention have the following advantages:

According to the unmanned aerial vehicle positioning method and unmanned aerial vehicle provided in the embodiments of the present invention, when it is determined to perform a hovering operation, the first ground image is collected as the reference image. Therefore, latest ground status can be reflected in real time. Because the second ground image collected at the current moment and the first ground image are both collected in a hovering process of the unmanned aerial vehicle, a change of a location at which the unmanned aerial vehicle is located when the unmanned aerial vehicle collects the second ground image relative to a location at which the unmanned aerial vehicle is located when the unmanned aerial vehicle collects the first ground image can be determined according to the first ground image and the second ground image. A stability degree of the unmanned aerial vehicle when the unmanned aerial vehicle performs the hovering operation can be determined by using the location change. A smaller location change indicates that hovering precision is higher and the unmanned aerial vehicle is more stable. When there is no location change, the unmanned aerial vehicle hovers stably. In addition, after the location change of the unmanned aerial vehicle is determined, the current location of the unmanned aerial vehicle can also be determined.

In a process in which the unmanned aerial vehicle collects the first image and the second image, an external environment of the unmanned aerial vehicle is the same or approximately the same. Compared with the prior art in which an uncontrollable factor results in a large positioning system error and absolute error, in the embodiments of the present invention, the current location of the unmanned aerial vehicle is determined according to the first ground image and the second ground image. Therefore, system errors caused by different resolutions resulting from different external environment factors can be reduced, and hovering positioning precision of the unmanned aerial vehicle is improved.

As an optional technical solution, matching is performed according to the reference characteristic point and the current characteristic point to obtain the motion vector of the unmanned aerial vehicle relative to the first ground image at the current moment, thereby reducing a data volume for performing matching between the second ground image and the first ground image.

### BRIEF DESCRIPTION OF THE DRAWINGS

To more explicitly explain technical solutions in specific implementations of the present invention or in the prior art, accompanying drawings needed to describe the specific implementations or the prior art are briefly introduced in the following. Apparently, the following accompanying drawings are some implementations of the present invention, and a person of ordinary skill in the art can derive other accompanying drawings from the accompanying drawings without any creative work.

FIG. 1 is a flowchart of an unmanned aerial vehicle positioning method according to an embodiment of the present invention;

FIG. 2 is a flowchart of obtaining a motion vector by using an affine transformation model according to an embodiment of the present invention;

FIG. 3 is a flowchart of obtaining a motion vector by using a projective transformation model according to an embodiment of the present invention;

FIG. 4 is a schematic structural diagram of an unmanned aerial vehicle positioning apparatus according to an embodiment of the present invention; and

FIG. 5 is a schematic structural diagram of an unmanned aerial vehicle according to an embodiment of the present invention.

### DETAILED DESCRIPTION

The following clearly describes the technical solutions of the present invention with reference to the accompanying drawings. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

In the description of the present invention, it should be noted that positions or position relationships indicated by terminologies such as “center”, “upper”, lower”, “left”, “right”, “vertical”, “horizontal”, “inner”, and “outer” are positions or position relationships based on the accompanying drawings, are only intended to facilitate and simplify description of the present invention, and do not indicate or imply that an indicated apparatus or component has to have a specific position, or be constructed and operated in a specific position; therefore, shall not be construed as a limitation on the present invention. In addition, terminologies “first”, “second”, and “third” are only for descriptive purpose, shall not be construed as indicating or implying relative importance, and shall not be construed as a sequence either.

In description of the present invention, it should be noted that, terminologies “installation”, “interconnection”, and “connection” should be understood in a broad sense, for example, may be a fixed connection, a detachable connection, or an integral connection; may be a mechanical connection or an electrical connection; may be a direct connection or may be an indirect connection that is made by using an intermediate medium; or may be a connection between interiors of two components, a wireless connection, or a wired connection, unless otherwise definitely stipulated and limited. A person of ordinary skill in the art may understand specific meanings of the foregoing terminologies in the present invention in a specific case.

In addition, the technical features in different implementations of the present invention described below may be combined with each other as long as there is no conflict.

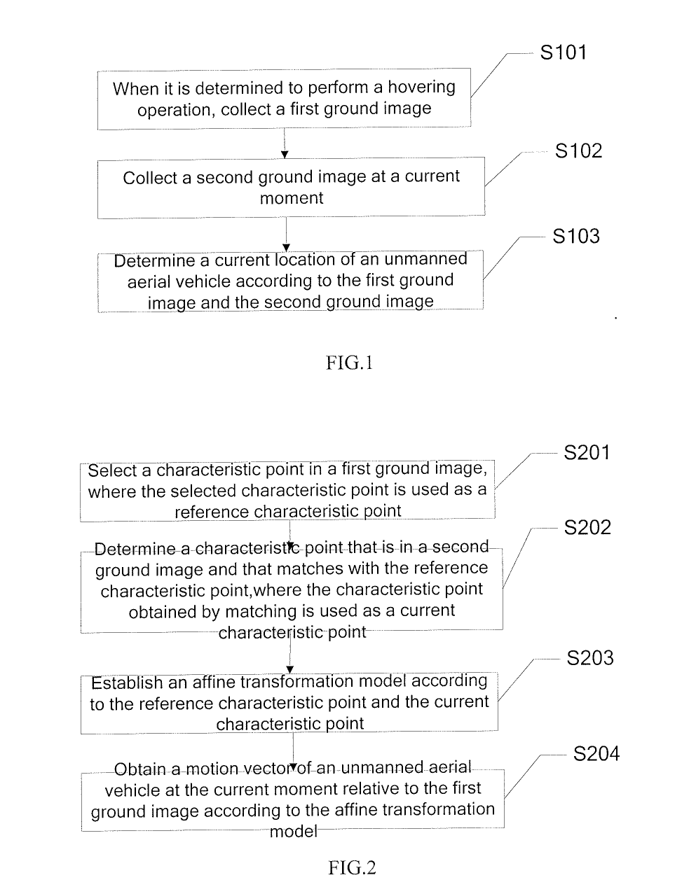

To improve hovering positioning precision of the unmanned aerial vehicle, this embodiment discloses an unmanned aerial vehicle positioning method. Referring to FIG. 1, the method includes:

Step S101: When it is determined to perform a hovering operation, collect a first ground image.

The first ground image is used as a reference image. In this embodiment, a ground image refers to an image collected by the unmanned aerial vehicle in a flight process at an overlooking vision angle, and an included angle between a direction of the overlooking vision angle and a vertical direction is less than 90 degrees. Preferably, the direction of the overlooking vision angle may be vertically downwards. In this case, the included angle between the direction of the overlooking vision angle and the vertical direction is 0 degree.

The unmanned aerial vehicle may determine to perform the hovering operation in multiple manners. In a manner, the unmanned aerial vehicle autonomously determines that the hovering operation needs to be performed. For example, when the unmanned aerial vehicle encounters a block or there is no GPS signal, a flight control system of the unmanned aerial vehicle autonomously determines that the hovering operation needs to be performed. In another possible manner, the unmanned aerial vehicle may be controlled by another device to perform the hovering operation. For example, the unmanned aerial vehicle may receive an instruction sent by a controller, wherein the instruction is used to instruct the unmanned aerial vehicle to perform the hovering operation.

After receiving the instruction, the unmanned aerial vehicle determines to perform the hovering operation. In this embodiment, the controller may be a handle-type remote control specially used by the unmanned aerial vehicle, or may be a terminal for controlling the unmanned aerial vehicle. The terminal may include a mobile terminal, a computer, a notebook, or the like.

It should be noted that, in this embodiment of the present invention, an interval between a moment for determining to perform the hovering operation and a moment for collecting the first ground image is not limited. In an implementation, after it is determined to perform the hovering operation, the first ground image is immediately collected. In another implementation, the first ground image is collected after a period of time starting from a moment at which it is determined to perform the hovering operation. For example, an image collected after a period of time starting from a moment at which it is determined to perform the hovering operation does not satisfy a requirement, recollection needs to be performed until an image that satisfies a requirement is collected, and the image that satisfies a requirement is used as the first ground image.

Step S102: Collect a second ground image at a current moment.

After the unmanned aerial vehicle hovers, to determine the current location of the unmanned aerial vehicle, an image collection apparatus may collect a ground image at the current moment, and the ground image collected at the current moment is referred to as the second ground image. It should be noted that, the image collection apparatus for collecting the second ground image and the image collection apparatus for collecting the first ground image may be a same image collection apparatus, or may be different image collection apparatuses. Preferably, the image collection apparatus for collecting the second ground image and the image collection apparatus for collecting the first ground image is a same image collection apparatus.

The second ground image is collected in a hovering process, and the second ground image and the first ground image are compared to determine a location change of the unmanned aerial vehicle.

Step S103: Determine a current location of an unmanned aerial vehicle according to the first ground image and the second ground image.

In this embodiment, after the first ground image is obtained, the second ground image and the first ground image may be compared, to obtain a difference between the second ground image and the first ground image, the motion vector of the unmanned aerial vehicle can be estimated according to the difference, and the current location of the unmanned aerial vehicle can be determined according to the motion vector.

Optionally, step S103 may specifically include: performing matching between the second ground image and the first ground image, to obtain a motion vector of the unmanned aerial vehicle relative to the first ground image at the current moment; and determining positioning information of the unmanned aerial vehicle at the current moment relative to the first ground image according to the motion vector.

Matching is performed between the second ground image and the first ground image to obtain the motion vector of a location at which the unmanned aerial vehicle is located at the current moment relative to a location at which the unmanned aerial vehicle is located when the first ground image is collected, and a location at which the unmanned aerial vehicle is located in the first ground image at the current moment can be obtained by using the motion vector.

In this embodiment, the positioning information includes at least one of the following: location of the unmanned aerial vehicle, height of the unmanned aerial vehicle, posture of the unmanned aerial vehicle, azimuth of the unmanned aerial vehicle, speed of the unmanned aerial vehicle, and flight direction of the unmanned aerial vehicle. The azimuth of the unmanned aerial vehicle refers to a relative angle between the current image collected by the unmanned aerial vehicle at the current moment and the reference image. Specifically, in this embodiment of the present invention, the azimuth is a relative angle between the second ground image and the first ground image. A flight direction of the unmanned aerial vehicle refers to an actual flight direction of the unmanned aerial vehicle.

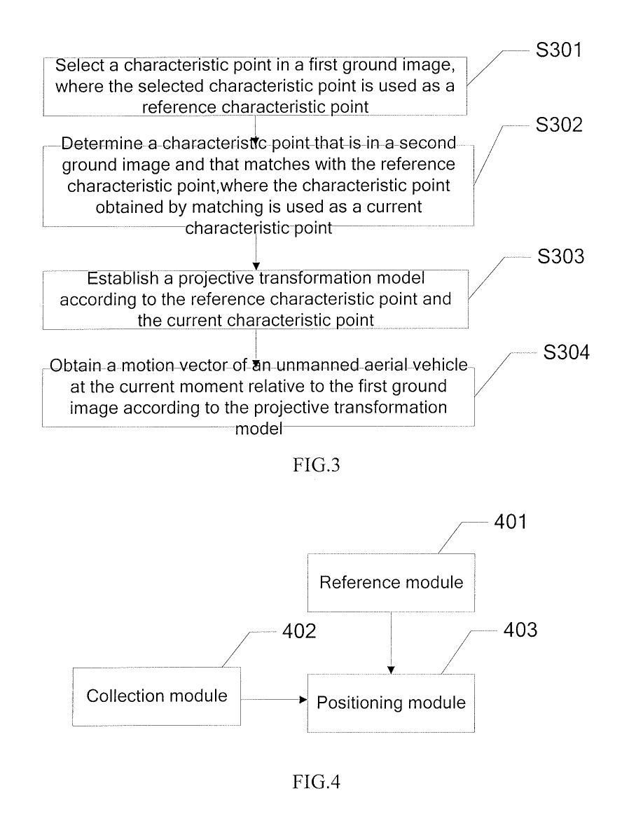

In a specific embodiment, the performing matching between the second ground image and the first ground image to obtain a motion vector of the unmanned aerial vehicle at the current moment relative to the first ground image includes: selecting a characteristic point in the first ground image, where the selected characteristic point is used as a reference characteristic point; determining a characteristic point that is in the second ground image and that matches with the reference characteristic point, where the characteristic point obtained by matching is used as a current characteristic point; and performing matching between the current characteristic point and the reference characteristic point, to obtain the motion vector of the unmanned aerial vehicle relative to the first ground image at the current moment. Specifically, in a process of performing matching between the current characteristic point and the reference characteristic point, matching may be performed between the current characteristic point and the reference characteristic point by means of affine transformation or projective transformation. For details, refer to FIG. 2 and FIG. 3.

FIG. 2 shows a method for obtaining a motion vector by using an affine transformation model. The method includes:

Step S201: Select a characteristic point in a first ground image, where the selected characteristic point is used as a reference characteristic point.

A point or a building that can be easily identified, for example, an object edge point with abundant textures may be selected as the reference characteristic point. Because three pairs of corresponding points that are not in a same line determine one unique affine transformation, as long as three groups of characteristic points that are not in a same line can be found, a complete affine transformation parameter can be calculated. If there are more than three groups of characteristic points, the least square method is preferably used to calculate a more precise affine transformation parameter. In this embodiment, the affine transformation parameter obtained by solving may be used to indicate the motion vector of the unmanned aerial vehicle.

Step S202: Determine a characteristic point that is in the second ground image and that matches with the reference characteristic point, where the characteristic point obtained by matching is used as a current characteristic point.

A same mathematical description manner may be used to describe pixels in the second ground image, and the current characteristic point that is in the second ground image and that matches with the reference characteristic point may be determined by using mathematical knowledge.

Step S203: Establish an affine transformation model according to the reference characteristic point and the current characteristic point.

The affine transformation model may be established by using equations or a matrix. Specifically, the affine transformation model established by using equations is as follows:

$$\{ \begin{matrix}{x}^{′} = ax + by + m \\ {y}^{′} = cx + dy + n\end{matrix} ,$$

(x, y) is coordinates of the reference characteristic point in the first ground image, (x′, y′) is coordinates of the characteristic point that is in the second ground image and that matches with the reference characteristic point, and a, b, c, d, m, and n are affine transformation parameters. In this embodiment, when the characteristic point obtained by means of matching is three groups of characteristic points that are not in a same line, a complete affine transformation parameter can be solved. When the characteristic point obtained by means of matching is more than three groups of characteristic points, the least square method may be used to solve a more precise affine transformation parameter.

Specifically, the affine transformation model established by using a matrix is as follows:

$$[ \begin{matrix}{x}^{′} \\ {y}^{′}\end{matrix} ] = [ \begin{matrix}a 2 & a 1 & a 0 \\ b 2 & b 1 & b 0\end{matrix} ] [ \begin{matrix}x \\ y \\ 1\end{matrix} ] ,$$

(x, y) is coordinates of the reference characteristic point in the first ground image, (x′, y′) is coordinates of the characteristic point that is in the second ground image and that matches with the reference characteristic point, and a0, a1, a2, b0, b1, and b2 are affine transformation parameters. In this embodiment, when the characteristic point obtained by means of matching is three groups of characteristic points that are not in a same line, a complete affine transformation parameter can be solved. When the characteristic point obtained by means of matching is more than three groups of characteristic points, the least square method may be used to solve a more precise affine transformation parameter.

Step S204: Obtain a motion vector of an unmanned aerial vehicle at the current moment relative to the first ground image according to the affine transformation model.

In this embodiment, the affine transformation parameters calculated according to the affine transformation model established in step S203 may be used to indicate the motion vector of the unmanned aerial vehicle.

FIG. 3 shows a method for obtaining a motion vector by using a projective transformation model. The method includes:

Step S301: Select a characteristic point in a first ground image, where the selected characteristic point is used as a reference characteristic point.

A point or a building that can be easily identified, for example, an object edge point with abundant textures may be selected as the reference characteristic point. In this embodiment, because there are eight to-be-calculated transformation parameters in the projective transformation model, four groups of reference characteristic points need to be selected.

Step S302: Determine a characteristic point that is in the second ground image and that matches with the reference characteristic point, where the characteristic point obtained by matching is used as a current characteristic point.

In a specific embodiment, same mathematical description manner may be used to describe pixels in the second ground image, and the current characteristic point that is in the second ground image and that matches with the reference characteristic point may be determined by using mathematical knowledge.

Step S303: Establish a projective transformation model according to the reference characteristic point and the current characteristic point.

The projective transformation model may be established by using equations. Specifically, the projective transformation model established by using equations is:

$$• [ \begin{matrix}{w}^{′} {y}^{′} & {w}^{′} {y}^{′} & {w}^{′}\end{matrix} ] = [ \begin{matrix}wx & wy & w\end{matrix} ] [ \begin{matrix}a 11 & a 12 & a 13 \\ a 21 & a 22 & a 23 \\ a 31 & a 32 & a 33\end{matrix} ] ,$$

(x, y) is coordinates of the reference characteristic point in the first ground image, (x′, y′) is coordinates of the characteristic point that is in the second ground image and that matches with the reference characteristic point, (w′x′ w′y ′w′) and (wx wy w) are respectively homogeneous coordinates of (x, y) and (x′, y′), and

$$[ \begin{matrix}a 11 & a 12 & a 13 \\ a 21 & a 22 & a 23 \\ a 31 & a 32 & a 33\end{matrix} ]$$

is a projective transformation matrix. In a specific embodiment, a transformation matrix

$$[ \begin{matrix}a 11 & a 12 & a 13 \\ a 21 & a 22 & a 23 \\ a 31 & a 32 & a 33\end{matrix} ]$$

may be divided into four parts.

$$[ \begin{matrix}a 11 & a 12 \\ a 21 & a 22\end{matrix} ]$$

indicates linear transformation, [a31 a32] is used for translation, [a13 a23]^{T} generates projective transformation, and a33=1.

Step S304: Obtain a motion vector of an unmanned aerial vehicle at the current moment relative to the first ground image according to the projective transformation model.

In this embodiment, a projective transformation matrix calculated according to the projective transformation model established in step S303 may be used to indicate the motion vector of the unmanned aerial vehicle.

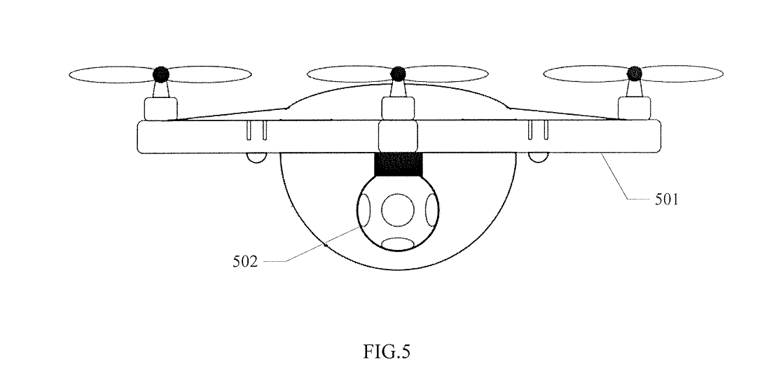

An embodiment further discloses an unmanned aerial vehicle positioning apparatus, as shown in FIG. 4. The apparatus includes: a reference module 401, a collection module 402, and a positioning module 403.

The reference module 401 is configured to: when it is determined to perform a hovering operation, collect a first ground image, where the first ground image is used as a reference image; the collection module 402 is configured to collect a second ground image at a current moment; and the positioning module 403 is configured to determine a current location of an unmanned aerial vehicle according to the first ground image collected by the reference module 401 and the second ground image collected by the collection module 402. In an optional embodiment, the apparatus further includes: an instruction module, configured to receive an instruction sent by a controller, wherein the instruction is used to instruct the unmanned aerial vehicle to perform the hovering operation. In an optional embodiment, the positioning module includes: a matching unit, configured to perform matching between the second ground image and the first ground image, to obtain a motion vector of the unmanned aerial vehicle relative to the first ground image at the current moment; and a determining unit, configured to determine positioning information of the unmanned aerial vehicle at the current moment relative to the first ground image according to the motion vector.

In an optional embodiment, the positioning information includes at least one of the following: location of the unmanned aerial vehicle, height of the unmanned aerial vehicle, posture of the unmanned aerial vehicle, azimuth of the unmanned aerial vehicle, speed of the unmanned aerial vehicle, and flight direction of the unmanned aerial vehicle.

In an optional embodiment, the matching unit includes: a reference characteristic subunit, configured to select a characteristic point in the first ground image, where the selected characteristic point is used as a reference characteristic point; a current characteristic subunit, configured to determine a characteristic point that is in the second ground image and that matches with the reference characteristic point, where the characteristic point obtained by matching is used as a current characteristic point; and a vector subunit, configured to perform matching between the current characteristic point and the reference characteristic point, to obtain the motion vector of the unmanned aerial vehicle relative to the first ground image at the current moment.

In an optional embodiment, the vector subunit is specifically configured to perform matching between the current characteristic point and the reference characteristic point by means of affine transformation or projective transformation.

In an implementation, the unmanned aerial vehicle positioning apparatus may be an unmanned aerial vehicle. The reference module 401 may be a photographing apparatus, for example, a camera or a digital camera. The collection module 402 may be a photographing apparatus, for example, a camera or a digital camera. The positioning module 403 may be a processor.

Optionally, the reference module 401 and the collection module 402 may be a same photographing apparatus.

The instruction module may be a radio signal receiver, for example, an antenna for receiving a Wireless Fidelity (WiFi) signal, an antenna for receiving an Long Term Evolution (LTE) radio communication signal and the like, or an antenna for receiving a Bluetooth signal.

An embodiment further discloses an unmanned aerial vehicle, as shown in FIG. 5. The unmanned aerial vehicle includes: an unmanned aerial vehicle body 501, an image collection apparatus 502, and a processor (not shown in the figure).

The unmanned aerial vehicle body 501 is configured to carry various components of the unmanned aerial vehicle, for example, a battery, an engine (a motor), a camera, and the like.

The image collection apparatus 502 is disposed in the unmanned aerial vehicle body 501, and the image collection apparatus 502 is configured to collect image data.

It should be noted that, in this embodiment, the image collection apparatus 502 may be a camera. Optionally, the image collection apparatus 502 may be configured for panoramic photographing. For example, the image collection apparatus 502 may include a multi-nocular camera, or may include a panoramic camera, or may include both a multi-nocular camera and a panoramic camera, to collect an image or a video from multiple angles.

The processor is configured to execute the method described in the embodiment shown in FIG. 1. According to the unmanned aerial vehicle positioning method and apparatus provided in the embodiments of the present invention, when it is determined to perform a hovering operation, the first ground image is collected as the reference image. Therefore, latest ground status can be reflected in real time. Because the second ground image collected at the current moment and the first ground image are both collected in a hovering process of the unmanned aerial vehicle, a change of a location at which the unmanned aerial vehicle is located when the unmanned aerial vehicle collects the second ground image relative to a location at which the unmanned aerial vehicle is located when the unmanned aerial vehicle collects the first ground image can be determined according to the first ground image and the second ground image. A stability degree of the unmanned aerial vehicle when the unmanned aerial vehicle performs the hovering operation can be determined by using the location change. A smaller location change indicates that hovering precision is higher and the unmanned aerial vehicle is more stable. When there is no location change, the unmanned aerial vehicle hovers stably. In addition, after the location change of the unmanned aerial vehicle is determined, the current location of the unmanned aerial vehicle can also be determined.

In a process in which the unmanned aerial vehicle collects the first image and the second image, an external environment of the unmanned aerial vehicle is the same or approximately the same. Compared with the prior art in which an uncontrollable factor results in a large positioning system error and absolute error, in the embodiments of the present invention, the current location of the unmanned aerial vehicle is determined according to the first ground image and the second ground image. Therefore, system errors caused by different resolutions resulting from different external environment factors can be reduced, and hovering positioning precision of the unmanned aerial vehicle is improved.

In an optional embodiment, matching is performed according to the reference characteristic point and the current characteristic point to obtain the motion vector of the unmanned aerial vehicle relative to the first ground image at the current moment, thereby reducing a data volume for performing matching between the second ground image and the first ground image.

A person skilled in the art should understand that the embodiments of the present invention may be provided as a method, a system, or a computer program product. Therefore, the present invention may use complete hardware embodiments, complete software embodiments, or embodiments that combine software and hardware. Moreover, the present invention may use a form of a computer program product that is implemented on one or more computer-usable storage media (including but not limited to a disk memory, a CD-ROM, an optical memory, and the like) that include computer-usable program code.

The present invention is described with reference to the flowcharts and/or block diagrams of the method, the device (system), and the computer program product according to the embodiments of the present invention. It should be understood that computer program instructions may be used to implement each process and/or each block in the flowcharts and/or the block diagrams and a combination of a process and/or a block in the flowcharts and/or the block diagrams. The computer program instruction may be provided for a processor of a general-purpose computer, a dedicated computer, a built-in processor, or another programmable data processing device to generate a machine, so that an instruction executed by a processor of a computer or another programmable data processing device generates an apparatus for implementing a function specified in one or a plurality of procedures in the flowcharts and/or one or a plurality of blocks in the block diagrams.

These computer program instructions may also be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or another programmable device provide steps for implementing a specific function in one or more processes in the flowcharts and/or in one or more blocks in the block diagrams.

Obviously, the foregoing embodiments are merely intended to clearly describe the examples used, instead of limiting implementations. A person of ordinary skill in the art may further make other different forms of changes or modifications based on the foregoing descriptions. This specification does not need to and cannot list all implementations. Changes or modifications made obviously based on this still fall within the protection scope of the present invention.

What is claimed is:

1. An unmanned aerial vehicle positioning method, comprising:
when determining to perform a hovering operation, collecting a first ground image, wherein the first ground image is used as a reference image;
collecting a second ground image at a current moment;
determining a current location of an unmanned aerial vehicle according to the first ground image and the second ground image.

2. The method according to claim 1, wherein before the collecting a first ground image, the method further comprises:
receiving an instruction sent by a controller, wherein the instruction is used to instruct the unmanned aerial vehicle to perform the hovering operation.

3. The method according to claim 1, wherein the determining a current location of an unmanned aerial vehicle according to the first ground image and the second ground image comprises: performing matching between the second ground image and the first ground image to obtain a motion vector of the unmanned aerial vehicle relative to the first ground image at the current moment; and determining positioning information of the unmanned aerial vehicle at the current moment relative to the first ground image according to the motion vector.

4. The method according to claim 3, wherein the positioning information comprises at least one of the following:
location of the unmanned aerial vehicle, height of the unmanned aerial vehicle, posture of the unmanned aerial vehicle, azimuth of the unmanned aerial vehicle, speed of the unmanned aerial vehicle, and flight direction of the unmanned aerial vehicle.

5. The method according to claim 3, wherein the performing matching between the second ground image and the first ground image to obtain a motion vector of the unmanned aerial vehicle at the current moment relative to the first ground image comprises:
selecting a characteristic point in the first ground image, wherein the selected characteristic point is used as a reference characteristic point;
determining a characteristic point that is in the second ground image and that matches with the reference characteristic point, wherein the characteristic point obtained by matching is used as a current characteristic point; and
performing matching between the current characteristic point and the reference characteristic point, to obtain the motion vector of the unmanned aerial vehicle relative to the first ground image at the current moment.

6. The method according to claim 5, wherein the performing matching between the current characteristic point and the reference characteristic point comprises:
performing matching between the current characteristic point and the reference characteristic point by means of affine transformation or projective transformation.

7. An unmanned aerial vehicle, comprising:
an image collection apparatus configured to collect a first ground image used as a reference image; and
a processor;
wherein the image collection apparatus is further configured to collect a second ground image at current moment;
wherein the processor is configured to determine a current location of the unmanned aerial vehicle according to the first ground image and the second ground image.

8. The unmanned aerial vehicle according to claim 7, further comprising:
a radio signal receiver configured to receive an instruction sent by a controller, wherein the instruction is used to instruct the unmanned aerial vehicle to perform the hovering operation.

9. The unmanned aerial vehicle according to claim 7, wherein the processor is configured to:
perform matching between the second ground image and the first ground image to obtain a motion vector of the unmanned aerial vehicle at the current moment relative to the first ground image; and
determine positioning information of the unmanned aerial vehicle at the current moment relative to the first ground image according to the motion vector.

10. The unmanned aerial vehicle according to claim 9, wherein the positioning information comprises at least one of the following:
location of the unmanned aerial vehicle, height of the unmanned aerial vehicle, posture of the unmanned aerial vehicle, azimuth of the unmanned aerial vehicle, speed of the unmanned aerial vehicle, and flight direction of the unmanned aerial vehicle.

11. The unmanned aerial vehicle according to claim 9, wherein the processor is configured to:
select a characteristic point in the first ground image, wherein the selected characteristic point is used as a reference characteristic point;
determine a characteristic point that is in the second ground image and that matches with the reference characteristic point, wherein the characteristic point in the second ground image is used as a current characteristic point;
perform matching between the current characteristic point and the reference characteristic point in order to obtain the motion vector of the unmanned aerial vehicle at the current moment relative to the first ground image.

12. The unmanned aerial vehicle according to claim 11, wherein the processor is configured to perform matching between the current characteristic point and the reference characteristic point by means of affine transformation or projective transformation.
